(19) United States
(12) Patent Application Publication
(10) Pub. No.: US 2011/0123880 A1
(43) Pub. Date: May 26, 2011

(54) HYDROGEN GENERATOR AND FUEL CELL SYSTEM INCLUDING THE SAME

(75) Inventors: Yuji Mukai, Osaka (JP); Akira Maenishi, Osaka (JP)

(73) Assignee: Sumitomo Electric Industries, Ltd, Osaka-shi (JP)

(21) Appl. No.: 12/376,663

(22) PCT Filed: Oct. 11, 2007
(86) PCT No.: PCT/JP2007/069838

§ 371 Date: Feb. 6, 2009

(30) Foreign Application Priority Data
Oct. 16, 2006 (JP) 2006-281079

(51) Int. Cl. H01M 8/06; B01J 8/04; G05B 1/00

(52) U.S. Cl. 429/423; 422/625; 422/105

(57) ABSTRACT

A hydrogen generator includes: a first tube (21), a first end of which is closed by a first lid plate (13); a combustor (6); a combustion gas passage (11); a second tube (22), a first end of which is closed by a second lid plate (14) having a hydrogen-containing gas flowing port (5) at a center thereof; a reformer (26) including a reforming catalyst layer (4); and a third tube (28), a first end of which is closed by a third lid plate (15), wherein: a plurality of hydrogen-containing gas rotational passages are formed in at least one of a second space (41) formed between the first lid plate (13) and a second lid plate (14) and a third space (42) formed between the second lid plate (14) and the third lid plate (15), so as to be arranged in a circumferential direction of the first tube (21); each of the rotational passages includes an entrance communicated with a first space (61) and an exit communicated with a fourth space (20) formed between the second tube (22) and the third tube (28); and a center of the entrance and a center of the exit deviate from each other so as to form a predetermined angle at an angular position around a central axis (50) of the first tube (21).

### TECHNICAL FIELD

The present invention relates to a hydrogen generator and a fuel cell system including the hydrogen generator, and particularly to the configuration of the hydrogen generator.

### BACKGROUND ART

A conventional hydrogen generator is configured to include a reformer which carries out a reforming reaction, a shift converter which carries out a shift reaction, and a CO remover which carries out an oxidation reaction. The conventional hydrogen generator generates hydrogen, reduces carbon monoxide (CO), and generates a gas containing hydrogen as a major component by operations of these reactors.

The reformer includes a reforming catalyst layer filled with a reforming catalyst made of a precious metal, such as ruthenium (Ru), platinum (Pt), or Rh (rhodium). With this, a hydrogen-containing gas containing hydrogen as a major component is generated from steam and a raw material containing an organic compound made of at least carbon and hydrogen, by a steam-reforming reaction using the reforming catalyst.

The shift converter includes a shift catalyst layer filled with a shift catalyst containing a copper-zinc (Cu—Zn) based material, an iron-chromium (Fe—Cr) based material, or a precious metal, such as Pt. With this, the CO in the hydrogen-containing gas delivered from the reformer is removed by the shift reaction using the shift catalyst to a concentration of about 1%.

The CO remover includes an oxidation catalyst layer filled with an oxidation catalyst containing a precious metal, such as Ru or Pt. With this, the CO in the hydrogen-containing gas delivered from the shift converter and premixed with air is reduced by the oxidation reaction using the oxidation catalyst to a predetermined CO concentration or lower (for example, 20 ppm or lower).

Examples of components around the reformer of the conventional hydrogen generator are shown in FIG. 9. As shown in FIG. 9, a reforming catalyst layer 4 disposed in an annular space formed between an inner tube 21 and an outer tube 22 is heated to 600° C. to 700° C. by a combustion gas flowing through a combustion gas passage 11 formed inside the inner tube 21. In this state, a mixture gas of the raw material supplied from a raw material supplier 1 and the steam generated by an evaporator 3 from water supplied from a water supplier 2 flows through the reforming catalyst layer 4. Thus, the hydrogen-containing gas is generated, and flows through a hydrogen-containing gas passage 20 formed outside the reforming catalyst layer 4 (see FIG. 2 of Patent Document 1 for example).

In the hydrogen generator described in Patent Document 1, as described above, the reforming catalyst layer 4 is heated to 600° C. to 700° C. by the combustion gas flowing through the combustion gas passage 11. However, typically, the flow rate of the combustion gas flowing through the combustion gas passage 11 becomes unstable due to inclined flame generated in a combustor 6. Thus, circumferential temperature variations of the reforming catalyst layer 4 are generated. Further, in a case where the flame in the combustor 6 inclines significantly, the flow rate of the combustion gas flowing through the combustion gas passage 11 located in a direction in which the flame inclines increases. Then, the reforming catalyst layer 4 located outside this combustion gas passage 11 is increased in temperature, and this may cause sintering. Thus, the durability of the catalyst may be damaged.

To solve these problems, a reforming device is known, in which: a triple wall surface including an inner side wall, an intermediate wall, and an outer side wall is formed on a ceiling portion covering an upper portion of a combusting portion (combustor) and coupled to a side wall upper portion of the reforming device; and an outward route of a reformed gas and a return route of the reformed gas, each of which returns at a through hole of the ceiling portion, are formed (see Patent Document 2 for example). In the reforming device disclosed in Patent Document 2, even if the temperature variations of the reformed gas flowing through the outward route are generated in the circumferential direction of the reforming catalyst layer due to the inclined flame generated in the combusting portion, the reformed gas having the temperature variations gathers at the through hole formed on the ceiling portion, and the reformed gas having temperature differences is mixed. Thus, the temperature variations are reduced.

Patent Document 1: Pamphlet of International Publication 00/63114

Patent Document 2: Japanese Laid-Open Patent Application Publication 2002-356306

### DISCLOSURE OF THE INVENTION

### Problems to be Solved by the Invention

However, even in the case of the reforming device disclosed in Patent Document 2, there is still room for improvement regarding the circumferential temperature variations of the reforming catalyst layer which are generated due to, for example, the unstable flow rate of the combustion gas flowing through a portion located inside the tubular reforming catalyst layer via the inner side wall.

The present invention was made in light of the above problems of the prior arts, and an object of the present invention is to provide a hydrogen generator capable of reducing the circumferential temperature variations of the tubular reforming catalyst layer and maintaining the durability of the reforming catalyst, and a fuel cell system including the hydrogen generator.

### Means for Solving the Problems

To solve the above problems, a hydrogen generator according to the present invention includes: a first tube, a first end of which is closed by a first lid plate; a combustor configured to generate flame directed from a second end of the first tube toward the first end of the first tube in an internal space of the first tube to combust a combustion fuel; a combustion gas passage configured to allow the combustion gas to flow therethrough along an inner surface of the first tube; a second tube, a first end of which is closed by a second lid plate having a hydrogen-containing gas flowing port at a center thereof, and which is disposed outside the first tube to be coaxial with the first tube and disposed such that the second lid plate is opposed to the first lid plate; a reformer including a reforming catalyst layer disposed in a tubular first space formed between the first tube and the second tube; and a third tube, a first end of which is closed by a third lid plate, and which is disposed outside the second tube to be coaxial with the second tube and disposed such that the third lid plate is opposed to the second lid plate, wherein: a plurality of hydrogen-containing gas rotational passages are formed in at least one of a second space formed between the first lid plate and the second lid plate and a third space formed between the second lid plate and the third lid plate, so as to be arranged in a circumferential direction of the first tube; each of the rotational passages include an entrance communicated with the first space and an exit communicated with a tubular fourth space formed between the second tube and the third tube; a center of the entrance and a center of the exit deviate from each other so as to form a predetermined angle at an angular position around a central axis of the first tube; a raw material and water are supplied from a second end of the second tube to the first space; a reforming reaction between the raw material and the water is carried out in the reforming catalyst layer by heat transferred from the combustion gas passage to generate a hydrogen-containing gas; and the hydrogen-containing gas flows from the first end of the first tube of the first space through the second space, the hydrogen-containing gas flowing port of the second lid plate, the third space, and the fourth space to an outside of the hydrogen generator.

With this, each of the rotational passages formed in at least one of the second space and the third space is configured to cause the hydrogen-containing gas to circle at a predetermined angle around the central axis of the first tube and flow through the fourth space formed outside the reforming catalyst layer. Therefore, even in a case where the circumferential temperature variations of the tubular reformer (reforming catalyst layer) are generated, the circumferential temperature variations of the reforming catalyst layer can be reduced since the low-temperature hydrogen-containing gas flows through a portion outside the high-temperature portion of the reforming catalyst layer, and the high-temperature hydrogen-containing gas flows through a portion outside the low-temperature portion of the reforming catalyst layer.

Moreover, in the hydrogen generator according to the present invention, the plurality of the rotational passages may be formed in the second space; the entrances (hereinafter referred to as “first entrances”) of the rotational passages (hereinafter referred to as “first rotational passages”) formed in the second space may be communicated with the first space; and the exits (hereinafter referred to as “first exits”) of the first rotational passages may be communicated with the fourth space via the hydrogen-containing gas flowing port.

Moreover, in the hydrogen generator according to the present invention, the center of the first entrance of the first rotational passage and the center of the first exit of the first rotational passage may deviate from each other so as to form an angle of 170 to 190 degrees at the angular position around the central axis of the first tube.

Moreover, in the hydrogen generator according to the present invention, the first rotational passages may be formed by dividing the second space using dividing walls extending in an axial direction of the first tube.

Moreover, in the hydrogen generator according to the present invention, the plurality of the rotational passages may be formed in the third space; the entrances (hereinafter referred to as “second entrances”) of the rotational passages (hereinafter referred to as “second rotational passages”) formed in the third space may be communicated with the first space via the hydrogen-containing gas flowing port; and the exits (hereinafter referred to as “second exits”) of the second rotational passages may be communicated with the fourth space.

Moreover, in the hydrogen generator according to the present invention, the center of the second entrance of the second rotational passage and the center of the second exit of the second rotational passage may deviate from each other so as to form an angle of 170 to 190 degrees at the angular position around the central axis of the first tube.

Moreover, in the hydrogen generator according to the present invention, the second rotational passages may be formed by dividing the third space using dividing walls extending in an axial direction of the first tube.

Moreover, the hydrogen generator according to the present invention includes: an inner tube; an outer tube; a reforming catalyst layer in an annular space between the inner tube and the outer tube; a reformer configured to reform a raw material flowing through the reforming catalyst layer to generate a hydrogen-containing gas; a combustion gas passage which is formed inside the inner tube and through which a combustion gas for heating the reforming catalyst layer flows; a combustor formed inside the inner tube to generate the combustion gas; and a hydrogen-containing gas passage which is formed outside the outer tube and through which the hydrogen-containing gas having flowed out from the reforming catalyst layer flows, wherein: the inner tube and the outer tube include a first lid plate and a second lid plate, respectively, on a downstream side of flow of the hydrogen-containing gas in the reforming catalyst layer; the hydrogen-containing gas having flowed through the space between the first lid plate and the second lid plate gather at a center of the second lid plate; and a hydrogen-containing gas flowing port is formed to allow the hydrogen-containing gas to flow therethrough to the hydrogen-containing gas passage.

With this, even in a case where the hydrogen-containing gas having flowed through the tubular reforming catalyst layer has the temperature variations in the circumferential direction of the reforming catalyst layer, the temperature variations of the hydrogen-containing gas are reduced since the hydrogen-containing gas gathers at the hydrogen-containing gas flowing port and is mixed. Moreover, since the hydrogen-containing gas whose temperature variations are reduced flows through the hydrogen-containing gas passage, the circumferential temperature variations of the reforming catalyst layer can be reduced. Further, since the circumferential temperature variations of the reforming catalyst layer are reduced, the durability of the reforming catalyst can be maintained.

Moreover, in the hydrogen generator according to the present invention, the space may be filled with a heat insulating material.

Moreover, in the hydrogen generator according to the present invention, the heat insulating material may contain alumina.

Moreover, in the hydrogen generator according to the present invention, the space may be filled with the reforming catalyst layer.

Moreover, the hydrogen generator according to the present invention may further include a temperature detector in a vicinity of the hydrogen-containing gas flowing port.

Further, the hydrogen generator according to the present invention may further include: a combustion gas adjuster configured to supply fuel to the combustor; and a controller, wherein the controller is configured to control an amount of the fuel supplied from the combustion gas adjuster to the combustor, based on a temperature detected by the temperature detector.

Moreover, a fuel cell system according to the present invention may include: the hydrogen generator; and a fuel cell configured to generate electric power using the hydrogen-containing gas supplied from the hydrogen generator.

The above object, other objects, features and advantages of the present invention will be made clear by the following detailed explanation of preferred embodiments with reference to the attached drawings.

### EFFECTS OF THE INVENTION

In accordance with the hydrogen generator of the present invention and the fuel cell system including the hydrogen generator, it is possible to reduce the circumferential temperature variations of the reforming catalyst which are caused by the unstable flow rate of the combustion gas flowing through a portion inside the tubular reforming catalyst layer, and therefore, it is possible to maintain the durability of the reforming catalyst.

### BRIEF DESCRIPTION OF THE DRAWINGS

FIG. 1 is a schematic diagram showing the configuration of a hydrogen generator of Reference Example 1.

FIG. 2 is a schematic diagram showing the configuration of the hydrogen generator of Reference Example 2.

FIG. 3 is a schematic diagram showing the configuration of the hydrogen generator of Reference Example 3.

FIG. 4 is a schematic diagram showing the configuration of the hydrogen generator according to Embodiment 1 of the present invention.

FIG. 5 is a schematic diagram showing the configuration of a first rotational passage of the hydrogen generator shown in FIG. 4.

FIG. 6 is a schematic diagram showing the configuration of the hydrogen generator according to Embodiment 3 of the present invention.

FIG. 7 is a schematic diagram showing a second rotational passage of the hydrogen generator shown in FIG. 6.

FIG. 8 is a schematic diagram showing the configuration of a fuel cell system according to Embodiment 5 of the present invention.

FIG. 9 is a schematic diagram showing the configuration of a conventional hydrogen generator.

FIG. 10 is a cross-sectional view taken along line X-X of FIG. 4.

FIG. 11 is a schematic diagram showing the configuration of the hydrogen generator according to Embodiment 2 of the present invention.

FIG. 12 is a schematic diagram showing the first rotational passage of the hydrogen generator shown in FIG. 11.

FIG. 13 is a schematic diagram showing the configuration of the hydrogen generator according to Embodiment 4 of the present invention.

FIG. 14 is a cross-sectional view taken along line XIV-XIV of FIG. 13.

FIG. 15 is a cross-sectional view taken along line XV-XV of FIG. 13.

### EXPLANATION OF REFERENCE NUMBERS

1 raw material supplier
2 water supplier
3 evaporator
4 reforming catalyst layer
5 hydrogen-containing gas flowing port
6 burner (combustor)
7 fuel supplier
8 air supplier
9 temperature detector
10 controller
11 combustion gas passage
12 exhaust port
13 first lid plate
14 second lid plate
15 third lid plate
16 first space
17 alumina layer
18 first rotational passage
18a first rotational passage
18b first rotational passage
18c first rotational passage
18d first rotational passage
19a dividing wall
19b dividing wall
19c dividing wall
19d dividing wall
20 hydrogen-containing gas passage (fourth space)
21 inner tube (first tube)
22 outer tube (second tube)
23 hydrogen generator
24 fuel cell
25 off gas passage
26 reformer
27 combustion tube
28 passage wall tube (third tube)
29 plate member
30 plate member
31 plate member
32 lid member
33 combustion space
34 combustion gas discharge passage
35 air supply passage
36 raw material supply entrance
37 raw material supply passage
38 pipe
39 water supply entrance
40 water supply passage
41 second space
42 third space
43 hydrogen-containing gas exit
44 fuel gas supply passage
45 raw material gas supply passage
46a mix suppressing wall
46b mix suppressing wall
47a dividing wall
47b dividing wall
47c dividing wall
47d dividing wall
48 second rotational passage
48a second rotational passage
48b second rotational passage
48c second rotational passage
48d second rotational passage
50 central axis
51a first entrance
51b first entrance
51c first entrance
51d first entrance
52a center
52b center
52c center
52d center
53a first exit
53b first exit
53c first exit
53d first exit
54a center
54b center
54c center
54d center
61 first space
100 fuel cell system
A region
B region

### BEST MODE FOR CARRYING OUT THE INVENTION

Hereinafter, the best mode for carrying out the present invention will be explained in reference to the drawings. In all the drawings, same reference numbers are used for the same or corresponding members, and a repetition of the same explanation is avoided.

### Embodiment 1

Configuration of Hydrogen Generator

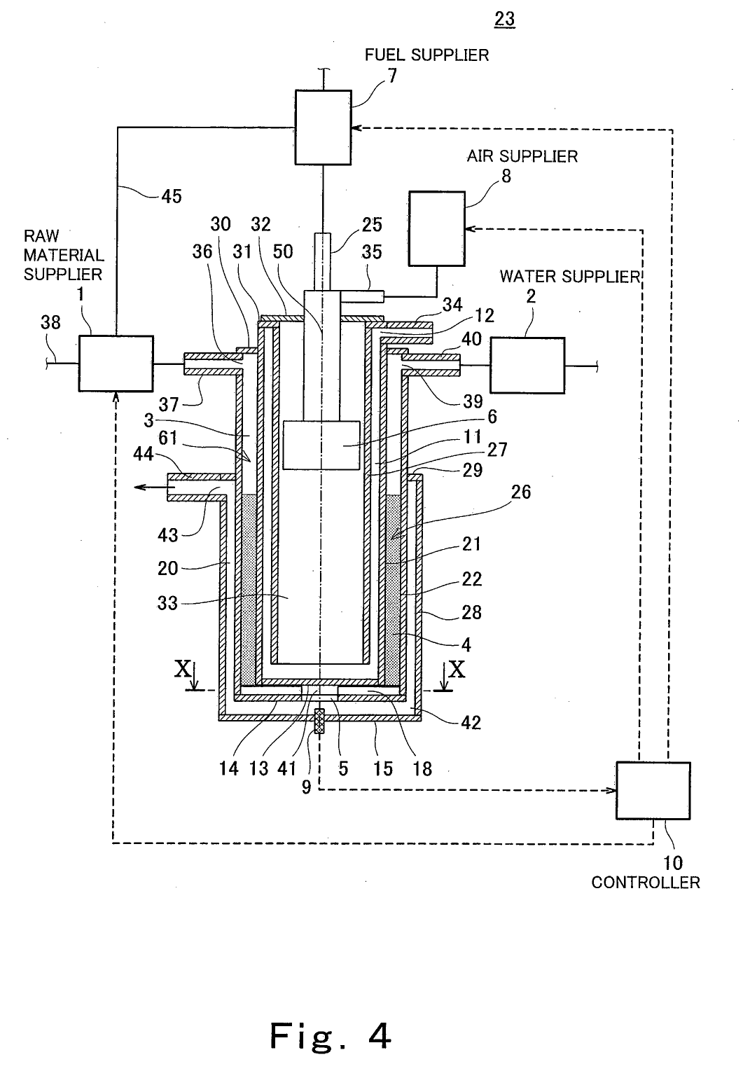

FIG. 4 is a schematic diagram showing the configuration of a hydrogen generator according to Embodiment 1 of the present invention.

As shown in FIG. 4, a hydrogen generator 23 according to Embodiment 1 includes a cylindrical combustion tube 27, an inner tube (first tube) 21, an outer tube (second tube) 22, and a passage wall tube (third tube) 28, which share a central axis 50 with one another. A lower end of the passage wall tube 28 is closed by a third lid plate 15, and an upper end thereof is closed by an annular plate member 29 connected to the outer tube 22. A lower end of the outer tube 22 is closed by a second lid plate 14 having at a center thereof a through hole 5 extending in a thickness direction of the second lid plate 14, and an upper end thereof is closed by an annular plate member 30 connected to the inner tube 21. A lower end of the inner tube 21 is closed by a first lid plate 13, and an upper end thereof is closed by an annular plate member 31 connected to a combustion tube 27. A lower end of the combustion tube 27 is open, and an upper end thereof is closed by a lid plate 32 connected to the plate member 31.

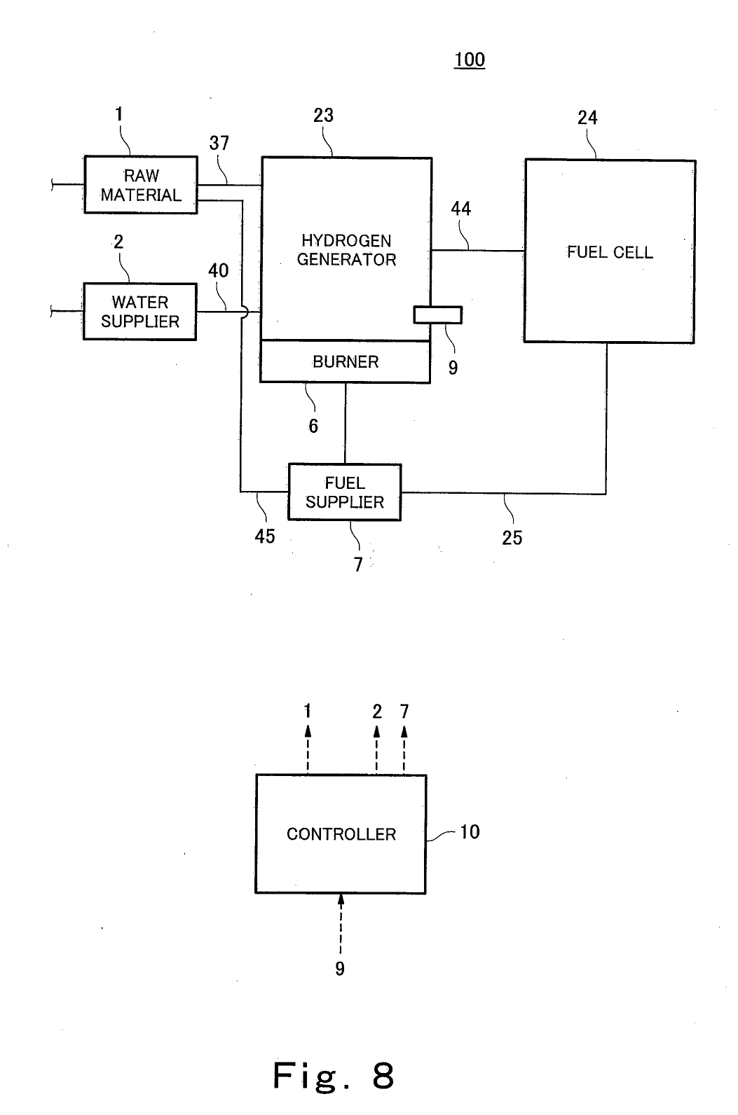

A burner (combustor) 6 is disposed at the lid plate 32 so as to extend downward in the combustion tube 27. A downstream end of a below-described off gas passage 25 is connected to the burner 6, and an upstream end thereof is connected to a below-described fuel cell 24 (see FIG. 8). A fuel supplier 7 is disposed on a portion of the off gas passage 25. A downstream end of a raw material gas supply passage 45 is connected to the fuel supplier 7, and an upstream end thereof is connected to the raw material supplier 1. In addition, a downstream end of an air supply passage 35 is connected to the burner 6, and an upstream end thereof is connected to an air supplier 8. Herein, the fuel supplier 7 is constituted by a three-way valve, and the air supplier 8 may be configured to be able to adjust the flow rate of air. For example, the air supplier 8 may be a pump capable of adjusting the amount of air ejected, or a flow control valve.

An internal space of the combustion tube 27 constitutes a combustion space 33. A space between the combustion tube 27 and the inner tube 21 constitutes the combustion gas passage 11. An exhaust port 12 is formed on a downstream side of the combustion gas passage 11, i.e., at an upper end portion of the inner tube 21, and a suitable pipe is connected to the exhaust port 12. This pipe constitutes a combustion gas discharge passage 34, and a downstream end of the combustion gas discharge passage 34 is open to the atmosphere.

With this, the burner 6 receives as fuel (combustion fuel) the fuel gas (off gas) which was not used in the fuel cell 24 or a city gas supplied from the raw material supplier 1, and combustion air supplied from the air supplier 8. The burner 6 combusts the supplied combustion fuel and air in the combustion space 33 to generate a combustion gas. The generated combustion gas flows out from a lower end of the combustion tube 27, hits an inner surface of the first lid plate 13 to reverse its flow direction, and flows through the combustion gas passage 11. At this time, a reformer 26 and the evaporator 3 are heated by heat transferred from the inner tube 21 constituting the combustion gas passage 11. The combustion gas having flowed through the combustion gas passage 11 is discharged through the combustion gas discharge passage 34 to the outside of the hydrogen generator 23.

A raw material supply entrance 36 which is communicated with a tubular space (hereinafter referred to as “first space 61”) formed between the inner tube 21 and the outer tube 22 is formed at an upper end portion of the inner tube 21, and a downstream end of a raw material supply passage 37 is connected to the raw material supply entrance 36. An upstream end of the raw material supply passage 37 is connected to the raw material supplier 1. The raw material supplier 1 includes a desulfurizer and a pump capable of adjusting the amount of the raw material ejected, and is connected to a pipe 38 of a city gas. A water supply entrance 39 which is communicated with the first space 61 is formed at the upper end portion of the inner tube 21, and a downstream end of a water supply passage 40 is connected to the water supply entrance 39. An upstream end of the water supply passage 40 is connected to the water supplier 2. The water supplier 2 is constituted by a pump capable of adjusting the amount of water ejected, and is connected to the city water.

With this, the raw material, i.e., the city gas from which a sulfur compound contained in the city gas as an odorant is adsorbed and removed (desulfrized) by the desulfurizer is supplied from the raw material supplier 1 through the raw material supply passage 37 to an upper portion of the first space 61, and the water is supplied from the water supplier 2 through the water supply passage 40 to the upper portion of the first space 61. Note that the upper portion of the first space 61 constitutes the evaporator 3.

The reforming catalyst layer 4 filled with the reforming catalyst is formed at a lower portion of the first space 61. A space where the reforming catalyst layer 4 of the first space 61 is formed and the reforming catalyst layer 4 constitute the reformer 26. Moreover, a first rotational passage 18 is formed on a downstream side of the reformer 26 in the first space 61 and in a space (hereinafter referred to as “second space 41”) between the first lid plate 13 and the second lid plate 14. Further, the through hole 5 is formed at the center of the second lid plate 14 and extends in the thickness direction of the second lid plate 14 such that a central axis thereof coincides with the central axis 50 of the inner tube 21. The through hole 5 constitutes a hydrogen-containing gas flowing port 5. A space between the second lid plate 14 and the third lid plate 15 constitutes a third space 42. Note that a detailed explanation of the first rotational passage 18 will be described later.

With this, the reformer 26 carries out a reforming reaction between the raw material and steam to generate a hydrogen-containing gas. The generated hydrogen-containing gas flows out from a downstream end of the reforming catalyst layer 4 to the second space 41, and then flows through the first rotational passage 18 and the hydrogen-containing gas flowing port 5 to the third space 42.

Moreover, a tubular space between the outer tube 22 and the passage wall tube 28 constitutes a hydrogen-containing gas passage (fourth space) 20. A shift converter and a purifier (both of which are not shown) are disposed on the hydrogen-containing gas passage 20. A hydrogen-containing gas exit 43 is formed at an upper end portion of the passage wall tube 28 so as to be communicated with the hydrogen-containing gas passage 20. An upstream end of a fuel gas supply passage 44 is connected to the hydrogen-containing gas exit 43. A downstream end of the fuel gas supply passage 44 is connected to the fuel cell 24. With this, the hydrogen-containing gas having flowed out to the third space 42 flows through the hydrogen-containing gas passage 20. At this time, the CO contained in the hydrogen-containing gas is reduced to a predetermined concentration (for example, 20 ppm) by the shift converter and the purifier, both of which are not shown. Then, the hydrogen-containing gas whose CO has been reduced is supplied through the fuel gas supply passage 44 to the fuel cell 24.

A temperature detector 9 is disposed at the center of the third lid plate 15 so as to penetrate through the third lid plate 15 such that a sensor portion thereof is located in the third space 42. The temperature detector 9 is configured to detect the temperature of the hydrogen-containing gas flowing out from the hydrogen-containing gas flowing port 5 and transmit the detected temperature to a controller 10. Used as the temperature detector 9 is a thermocouple, a thermistor, or the like. Herein, the temperature detector 9 is disposed to penetrate through the third lid plate 15. However, the present embodiment is not limited to this. The temperature detector 9 may be disposed such that the sensor portion thereof is located on an outer surface of the second lid plate 15. To accurately detect the temperature of the hydrogen-containing gas flowing out from the hydrogen-containing gas flowing port 5, it is preferable that the sensor portion be located on the central axis (central axis of the hydrogen-containing gas flowing port 5) 50 of the inner tube 21.

The controller 10 is constituted by a computer, such as a microcomputer, and carries out various control. Especially, based on the temperature detected by the temperature detector 9, the controller 10 controls, for example, the flow rate of the raw material supplied from the raw material supplier 1 to the hydrogen generator 23.

Next, the configuration of the first rotational passage 18 will be explained in detail in reference to FIGS. 4, 5, and 10.

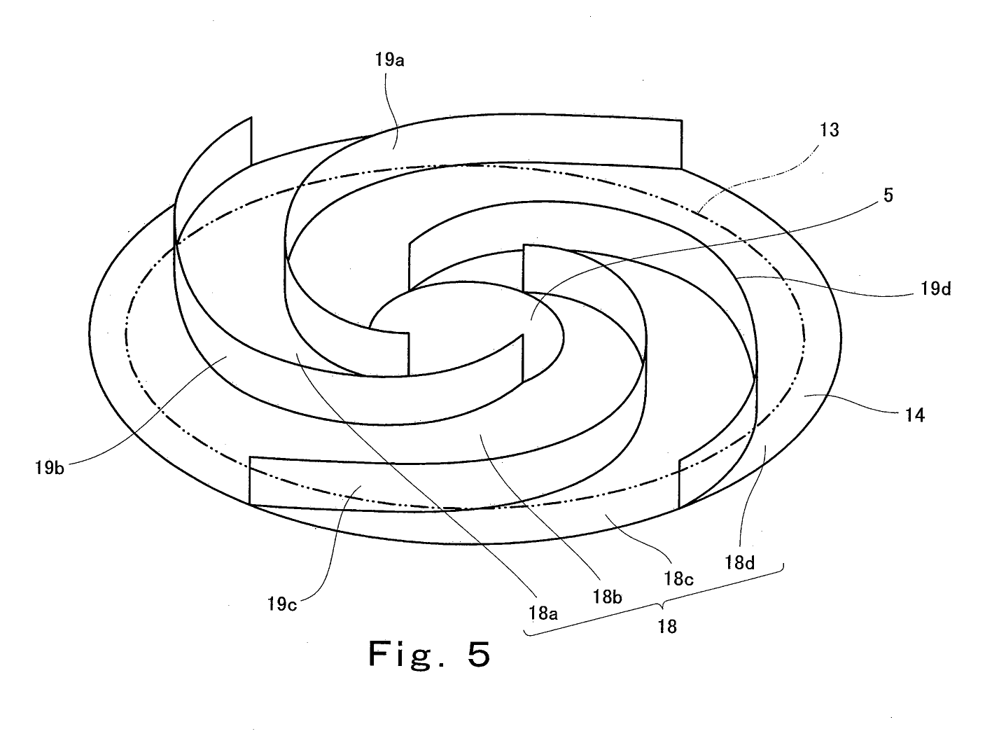

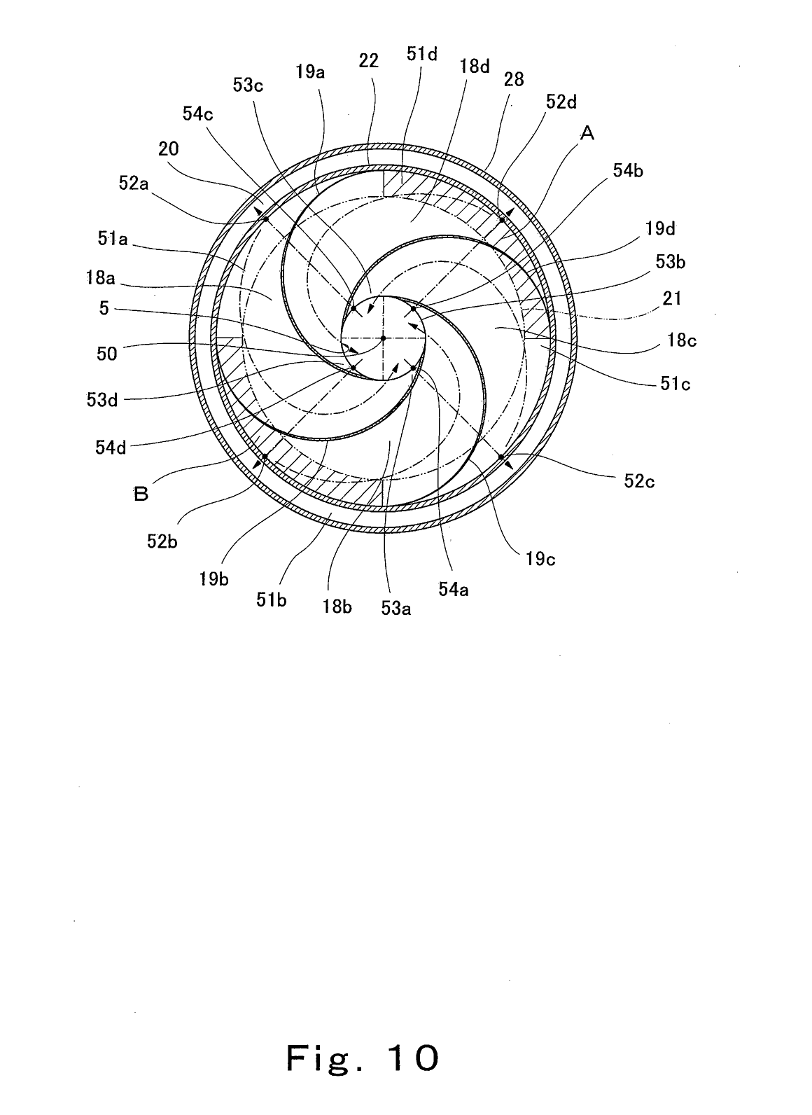

FIG. 5 is a schematic diagram showing the configuration of the first rotational passage 18 of the hydrogen generator 23 shown in FIG. 4. FIG. 10 is a cross-sectional view taken along line X-X of FIG. 4. In FIG. 5, a part of the hydrogen generator 23 is omitted.

As shown in FIGS. 4, 5, and 10, the first rotational passage 18 is formed in the second space 41. Herein, the first rotational passage 18 is constituted by four first rotational passages 18a to 18d and formed by dividing walls 19a to 19d. The dividing walls 19a to 19d are formed to extend radially (be arranged in a circumferential direction of the first tube 21) and spirally from the opening of the hydrogen-containing gas flowing port 5 toward the inner peripheral surface of the outer tube 22. Moreover, each of the dividing walls 19a to 19d are arranged such that an angle formed by a hydrogen-containing gas flowing port 5 side end portion of the dividing wall, the central axis 50 of the inner tube 21, and an outer tube 22 side end portion of the dividing wall is 180 degrees. Moreover, lower ends of the dividing walls 19a to 19d are connected to a main surface (hereinafter referred to as “inner surface”) of the second lid plate 14 which surface is opposed to the first lid plate 13, and upper ends thereof are located close to a main surface (hereinafter referred to as “outer surface”) of the first lid plate 13 which surface is opposed to the second lid plate 14. In other words, the height of each of the dividing walls 19a to 19d is substantially the same as the height (distance from the lower end of the inner tube 21 to the lower end of the outer tube 22) of the second space 41. Lower end portions of the dividing walls 19a to 19d are connected to the inner surface of the second lid plate 14.

Then, a space between the dividing wall 19a and the dividing wall 19b in the second space 41 constitutes the rotational passage 18a. Similarly, a space between the dividing wall 19b and the dividing wall 19c constitutes the rotational passage 18b, a space between the dividing wall 19c and the dividing wall 19d constitutes the rotational passage 18c, and a space between the dividing wall 19d and the dividing wall 19a constitutes the rotational passage 18d. The rotational passages 18a to 18d include first entrances 51a to 51d, respectively, which are communicated with the first space 61, and first exits 53a to 53d, respectively, which are communicated with the hydrogen-containing gas flowing port 5. Each of the rotational passages 18a to 18d is formed such that a center (52a to 52d) of the first entrance (51a to 51d) and a center (54a to 54d) of the first exit (53a to 53d) deviate from each other so as to form a predetermined angle (herein, 180 degrees) at an angular position around the central axis 50 of the inner tube 21. Here, the center 52a of the first entrance 51a is equidistant from an outer tube 22 side end portion of the dividing wall 19a and an outer tube 22 side end portion of the dividing wall 19b at the first entrance 51a. Similarly, the center 54a of the first exit 53a is equidistant from a hydrogen-containing gas flowing port 5 side end portion of the dividing wall 19a and a hydrogen-containing gas flowing port 5 side end portion of the dividing wall 19b at the first exit 53a. Note that centers 52b to 52d of the first entrance 51b to 51d and centers 54b to 54d of the first exits 53b to 53d are formed in the same manner as the center 52a of the first entrance 51a and the center 54a of the first exit 53a.

With this, the hydrogen-containing gas having flowed out from the reforming catalyst layer 4 of the reformer 26 flows into the entrances 51a to 51d of the rotational passages 18a to 18d. As shown by dashed lines of FIG. 10, the hydrogen-containing gas having flowed into the entrances 51a to 51d of the rotational passages 18a to 18d flows through the rotational passages 18a to 18d so as to circle at 180 degrees around the central axis 50. Then, the hydrogen-containing gas reaches and passes through the hydrogen-containing gas flowing port 5. At this time, since the hydrogen-containing gases in the rotational passages 18a to 18d flow at the same rate as one another, and are comparatively high in temperature and viscosity, they are mixed in the vicinity of a dotted line portion of the hydrogen-containing gas flowing port 5 shown in FIG. 10 but are not mixed at the other portions. As if the hydrogen-containing gas is pressed downward, it passes through the hydrogen-containing gas flowing port 5 and flows out to the third space 42. Then, the hydrogen-containing gas having flowed out to the third space 42 is not mixed but flows through the third space 42 so as to spread in a radial direction of the inner tube 21. The hydrogen-containing gas reaches the vicinity of an inner surface of the passage wall tube 28, and flows through a portion of the hydrogen-containing gas passage 20 which portion is opposed to the entrances 51a to 51d of the rotational passages 18a to 18d.

Therefore, even if circumferential temperature variations of the reforming catalyst layer 4 are generated, they can be reduced because of reasons below.

For example, when the flame generated in the combustor 6 inclines, a portion (region A shown in FIG. 10) of the reforming catalyst layer 4 which portion is close to the inclined flame may become high in temperature. In contrast, since a portion (region B shown in FIG. 10) of the reforming catalyst layer 4 which portion is opposed to the region A via the central axis 50 is located away from the inclined flame generated in the combustor 4, it may become low in temperature. In this case, the hydrogen-containing gas having flowed out from the high-temperature portion (region A) of the reforming catalyst layer 4 becomes higher in temperature than the hydrogen-containing gas having flowed out from the low-temperature portion (region B) of the reforming catalyst layer 4.

Then, the hydrogen-containing gas having flowed out from the high-temperature portion (region A) of the reforming catalyst layer 4 flows through the rotational passage 18d so as to circle at 180 degrees around the central axis 50 of the inner tube 21. While maintaining its high temperature state, the hydrogen-containing gas passes through the hydrogen-containing gas flowing port 5. The hydrogen-containing gas flows through the third space 42 while spreading toward the region B, and flows through a portion of the hydrogen-containing gas passage 20 which portion is located outside the low-temperature portion (region B) of the reforming catalyst layer 4. With this, the low-temperature portion of the reforming catalyst layer 4 is heated by heat transferred from the high-temperature hydrogen-containing gas via the outer tube 22. Thus, the low-temperature portion of the reforming catalyst layer 4 is increased in temperature.

In contrast, the hydrogen-containing gas having flowed out from the low-temperature portion (region B) of the reforming catalyst layer 4 flows through the rotational passage 18b so as to circle at 180 degrees around the central axis 50 of the inner tube 21. While maintaining its low temperature state, the hydrogen-containing gas passes through the hydrogen-containing gas flowing port 5. The hydrogen-containing gas flows through the third space 42 while spreading toward the region A, and flows through a portion of the hydrogen-containing gas passage 20 which portion is located outside the high-temperature portion (region A) of the reforming catalyst layer 4. With this, the low-temperature hydrogen-containing gas extracts heat from the high-temperature portion of the reforming catalyst layer 4 via the outer tube 22. Thus, the high-temperature portion of the reforming catalyst layer 4 is decreased in temperature.

As above, the low-temperature portion of the reforming catalyst layer 4 is increased in temperature, and the high-temperature portion of the reforming catalyst layer 4 is decreased in temperature. Therefore, in accordance with the hydrogen generator 23 according to Embodiment 1, it is possible to reduce the circumferential temperature variations of the reforming catalyst layer 4.

In the present embodiment, the first rotational passage 18 is formed by the dividing walls 19a to 19d, and is formed such that the center (52a to 52d) of the first entrance (51a to 51d) of the first rotational passage (18a to 18d) and the center (54a to 54d) of the first exit (53a to 53d) of the first rotational passage (18a to 18d) deviate from each other so as to form 180 degrees at the angular position around the central axis 50 of the inner tube 21. With this, the hydrogen-containing gas having flowed into the second space 41 circles at 180 degrees around the central axis 50 of the inner tube 21. Thus, the circumferential temperature variations of the reforming catalyst layer 4 are reduced. However, the present embodiment is not limited to this. As long as the center (52a to 52d) of the first entrance (51a to 51d) and the center (54a to 54d) of the first exit (53a to 53d) deviate from each other so as to form about 170 to 190 degrees at the angular position around the central axis 50 of the inner tube 21, it is possible to obtain the same operational advantages as the case where the hydrogen-containing gas having flowed out from the reforming catalyst layer 4 circles at 180 degrees around the central axis 50 of the inner tube 21.

Moreover, an angle (angle formed at the angular position around the central axis 50 of the inner tube 21 by the center (52a to 52d) of the first entrance (51a to 51d) and the center (54a to 54d) of the first exit (53a to 53d)) at which the hydrogen-containing gas circles around the central axis 50 of the inner tube 21 by the first rotational passage 18 is an angle (angle formed by the high-temperature portion of the reforming catalyst layer 4, the central axis 50 of the inner tube 21, and the low-temperature portion of the reforming catalyst layer 4) preset based on the temperature of the hydrogen-containing gas having flowed out from the reformer 26 (reforming catalyst layer 4) around the central axis 50 of the inner tube 21. Such angle may be appropriately set by measuring in advance the temperature variations of the hydrogen-containing gas having flowed out from the reforming catalyst layer or by simulating the temperature distribution of the hydrogen-containing gas in the reforming catalyst layer 4.

Operations of Hydrogen Generator

Next, operations of the hydrogen generator 23 according to Embodiment 1 will be explained in reference to FIGS. 4, 5, and 10. Note that the following operations are controlled by the controller 10.

First, the fuel supplier 7 connects the raw material supplier 1 to the burner 6 through the raw material gas supply passage 45 and the off gas passage 25. The combustion gas is supplied from the raw material supplier 1 through the raw material gas supply passage 45 and the off gas passage 25 to the burner 6. At the same time, the combustion air is supplied from the air supplier 8 through the air supply passage 35 to the burner 6. The burner 6 combusts the supplied combustion gas and air to generate the combustion gas. The generated combustion gas flows out from the lower end of the combustion tube 27, hits the inner surface of the first lid plate 13 to reverse its flow direction, flows through the combustion gas passage 11 and the combustion gas discharge passage 34, and is discharged to the outside of the hydrogen generator 23.

Moreover, the raw material is supplied from the raw material supplier 1 through the raw material supply passage 37 to the evaporator 3 of the hydrogen generator 23, and the water is supplied from the water supplier 2 through the water supply passage 40 to the evaporator 3 of the hydrogen generator 23. The raw material and water supplied to the evaporator 3 are heated while flowing through the evaporator 3, and the water is turned into the steam. Then, the heated raw material and the steam are supplied to the reformer 26.

The reformer 26 carries out the reforming reaction between the raw material and the steam by the reforming catalyst layer 4 to generate the reformed gas (hydrogen-containing gas) containing hydrogen, carbon monoxide, carbon dioxide, and the steam. The generated reformed gas flows out from the lower end of the reformer 26 and flows into the second space 41. The reformed gas having flowed into the second space 41 flows through the rotational passages 18a to 18d so as to circle at 180 degrees around the central axis 50 of the inner tube 21. Then, the reformed gas passes through the hydrogen-containing gas flowing port 5 and flows into the third space 42. The reformed gas having flowed out to the third space 42 is not mixed but flows through the third space 42 so as to spread in the radial direction, and is supplied to the hydrogen-containing gas passage 20.

While the reformed gas supplied to the hydrogen-containing gas passage 20 is flowing through the hydrogen-containing gas passage 20, the carbon monoxide in the reformed gas is reduced to a predetermined concentration (for example, 20 ppm) by the shift converter and the purifier, both of which are not shown. Thus, the fuel gas is generated. Then, the generated fuel gas is supplied through the fuel gas supply passage 44 to the fuel cell 24.

As above, the hydrogen generator 23 according to Embodiment 1 is configured such that the hydrogen-containing gas circles at a predetermined angle (herein, 180 degrees) around the central axis of the inner tube 21 by the first rotational passage 18 formed in the second space 41, and flows through the hydrogen-containing gas passage 20 formed outside the reforming catalyst layer 4. Therefore, even if the circumferential temperature variations of the tubular reformer 26 (reforming catalyst layer 4) are generated, it is possible to reduce the circumferential temperature variations of the reforming catalyst layer 4, since the low-temperature hydrogen-containing gas flows through the portion of the hydrogen-containing gas passage 20 which portion is located outside the high-temperature portion of the reforming catalyst layer 4, and the high-temperature hydrogen-containing gas flows through the portion of the hydrogen-containing gas passage 20 which portion is located outside the low-temperature portion of the reforming catalyst layer 4.

### Embodiment 2

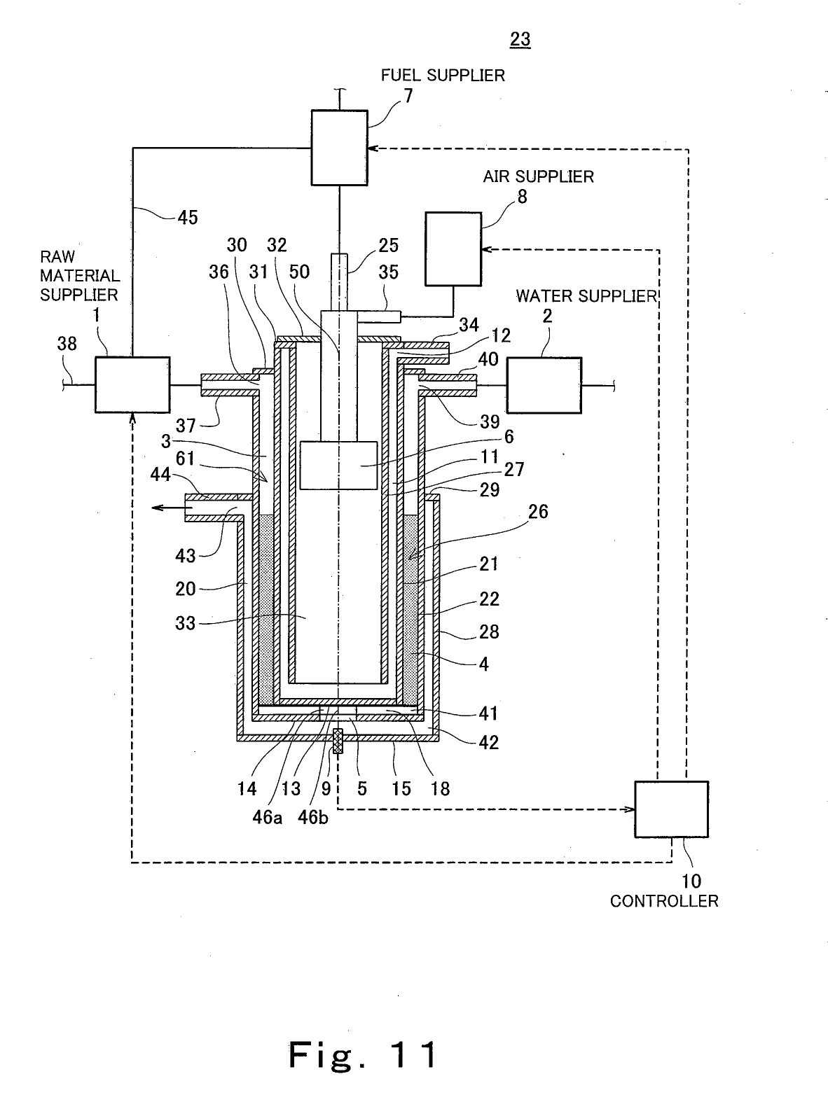

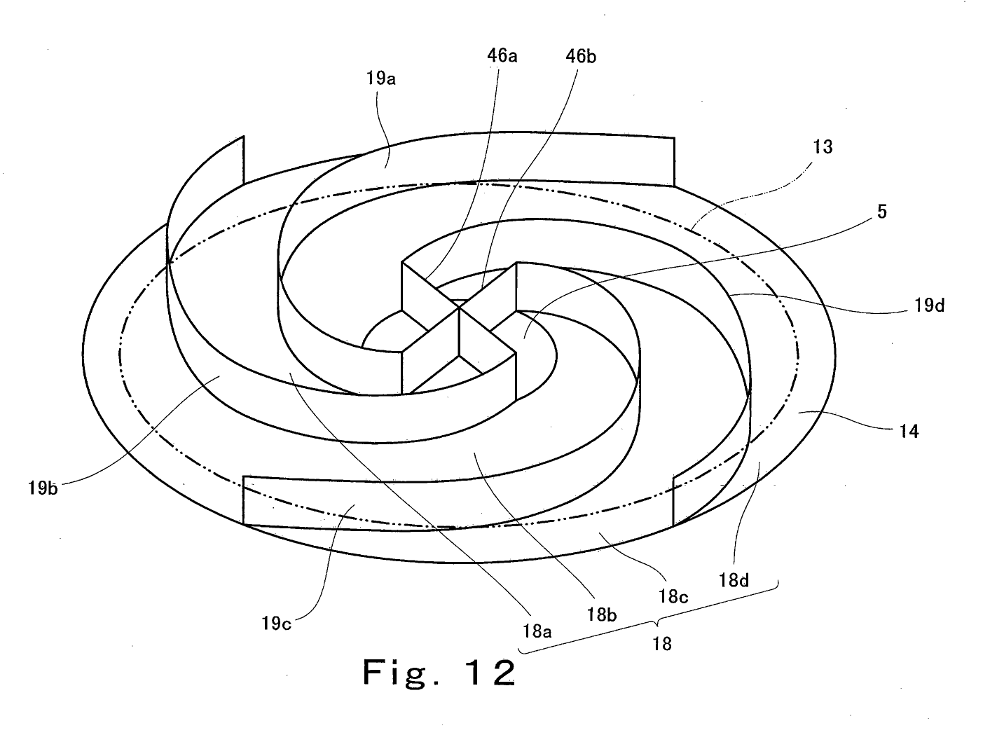

FIG. 11 is a schematic diagram showing the configuration of the hydrogen generator according to Embodiment 2 of the present invention. FIG. 12 is a schematic diagram showing the first rotational passage of the hydrogen generator shown in FIG. 11.

As shown in FIGS. 11 and 12, the hydrogen generator 23 according to Embodiment 2 of the present invention and the hydrogen generator 23 according to Embodiment 1 of the present invention are the same in basic configuration as each other, but are different from each other in that the first rotational passage 18 is formed by the dividing walls 19a to 19d and mix suppressing walls 46a and 46b.

Specifically, the mix suppressing wall 46a is formed on the hydrogen-containing gas flowing port 5 so as to connect a hydrogen-containing gas flowing port 5 side end of the dividing wall 19b and a hydrogen-containing gas flowing port 5 side end of the dividing wall 19d. The mix suppressing wall 46b is formed on the hydrogen-containing gas flowing port 5 so as to connect a hydrogen-containing gas flowing port 5 side end of the dividing wall 19a and a hydrogen-containing gas flowing port 5 side end of the dividing wall 19c and to intersect with (be orthogonal to) the mix suppressing wall 46a at the center of the hydrogen-containing gas flowing port 5. Each of the mix suppressing walls 46a and 46b is formed to have substantially the same height as each of the dividing walls 19a to 19d.

With this, the hydrogen-containing gases having flowed through the rotational passages 18a to 18d can be prevented from being mixed with one another at the hydrogen-containing gas flowing port.

Such hydrogen generator 23 according to Embodiment 2 can obtain the same operational advantages as the hydrogen generator 23 according to Embodiment 1.

### Embodiment 3

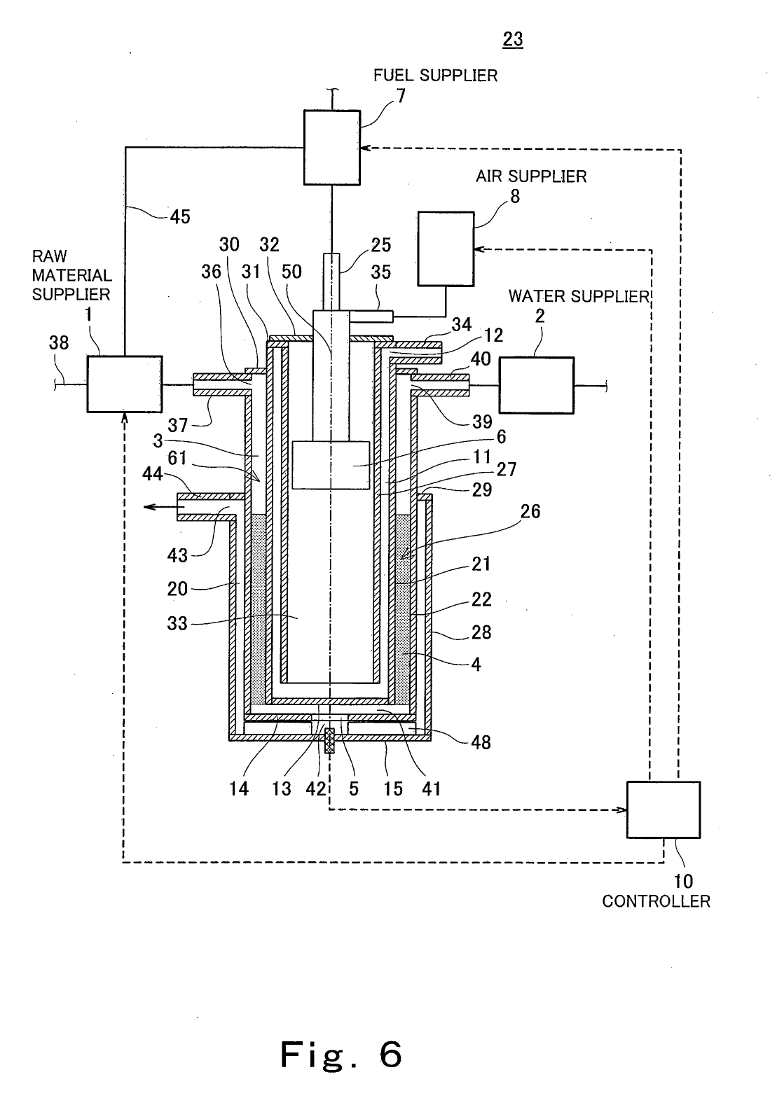

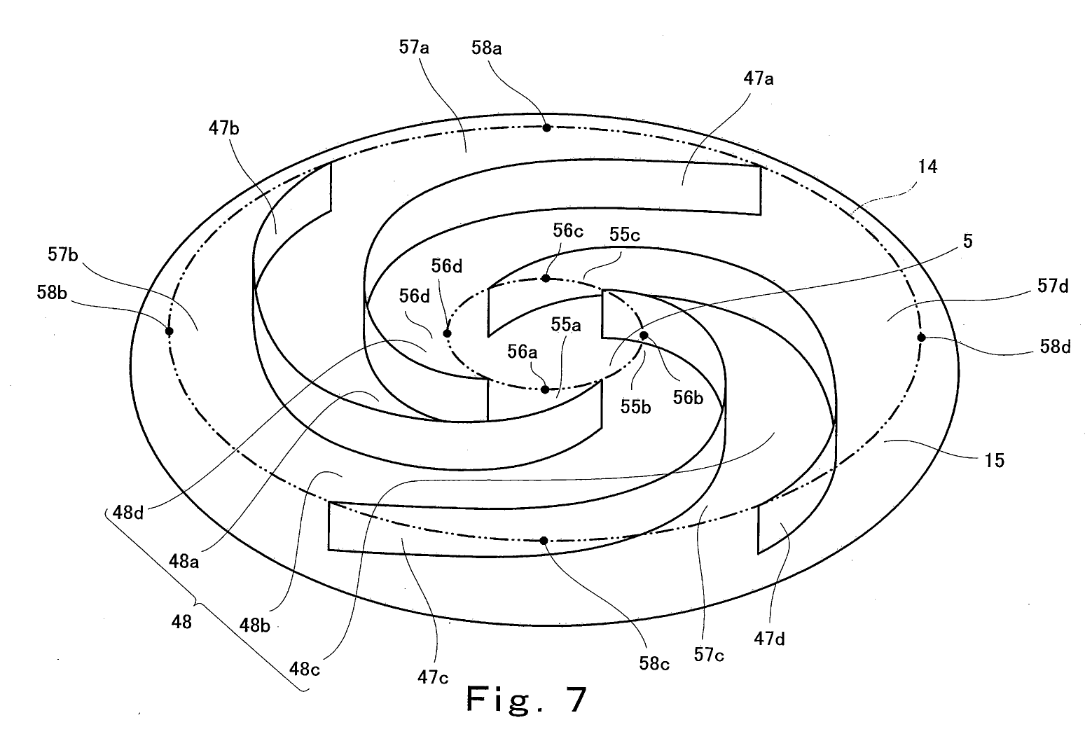

FIG. 6 is a schematic diagram showing the configuration of the hydrogen generator according to Embodiment 3 of the present invention. FIG. 7 is a schematic diagram showing a second rotational passage of the hydrogen generator shown in FIG. 6.

As shown in FIGS. 6 and 7, the hydrogen generator 23 according to Embodiment 3 of the present invention and the hydrogen generator 23 according to Embodiment 1 of the present invention are the same in basic configuration as each other, but are different from each other in that the first rotational passage 18 is not formed in the second space 41, but a second rotational passage 48 is formed in the third space 42.

The second rotational passage 48 is constituted by second rotational passages 48a to 48 and is formed by dividing walls 47a to 47d. The dividing walls 47a to 47d are configured in the same manner as the dividing walls 19a to 19d of Embodiment 1 except that respective lower ends of the dividing walls 47a to 47d are connected to a main surface of the third lid plate 15 which surface is opposed to the second lid plate 14, and respective upper ends thereof are close to a rear surface of the second lid plate. Therefore, detailed explanations of the dividing walls 47a to 47d are omitted.

A space between the dividing wall 47a and the dividing wall 47b in the third space 42 constitutes the rotational passage 48a. Similarly, a space between the dividing wall 47b and the dividing wall 47c constitutes the rotational passage 48b, a space between the dividing wall 47c and the dividing wall 47d constitutes the rotational passage 48c, and a space between the dividing wall 47d and the dividing wall 47a constitutes the rotational passage 48d. The rotational passages 48a to 48d include second entrances 55a to 55d, respectively, which are communicated with the hydrogen-containing gas flowing port 5, and second exits 57a to 57d, respectively, which are communicated with the hydrogen-containing gas passage 20. Each of the rotational passages 48a to 48d is formed such that a center (56a to 56d) of the second entrance (55a to 55d) and a center (58a to 58d) of the second exit (57a to 57d) deviate from each other so as to form a predetermined angle (herein, 180 degrees) at the angular position around the central axis 50 of the inner tube 21. Here, the center 56a of the second entrance 55a is equidistant from a hydrogen-containing gas flowing port 5 side end portion of the dividing wall 47a and a hydrogen-containing gas flowing port 5 side end portion of the dividing wall 47b at the second entrance 55a. Similarly, the center 58a of the second exit 57a is equidistant from an outer tube 22 side end portion of the dividing wall 47a and an outer tube 22 side end portion of the dividing wall 47b at the second exit 57a. Note that centers 56b to 56d of the second entrances 55b to 55d and centers 58b to 58d of the second exits 57b to 57d are formed in the same manner as the center 56a of the second entrance 55a and the center 58a of the second exit 57a.

Then, by designing the opening of the hydrogen-containing gas flowing port 5 to have a suitable size, the hydrogen-containing gas having flowed out from the reforming catalyst layer 4 of the reformer 26 to the second space 41 is not mixed but can flow toward the central axis 50 (hydrogen-containing gas flowing port 5) of the inner tube 21 in the radial direction of the inner tube 21, reach the hydrogen-containing gas flowing port 5, and pass through the hydrogen-containing gas flowing port 5 as if it is pressed downward.

With this, in a case where the circumferential temperature variations of the reforming catalyst layer 4 are generated, the temperature variations of the hydrogen-containing gas having flowed through the reforming catalyst layer 4 are also generated, and the hydrogen-containing gas can pass through the hydrogen-containing gas flowing port 5 while maintaining the temperature variations. Then, since the hydrogen-containing gas having passed through the hydrogen-containing gas flowing port 5 flows through the rotational passages 48a to 48d so as to circle at a predetermined angle (herein, 180 degrees) around the central axis 50 of the inner tube 21, the high-temperature hydrogen-containing gas can be supplied to the portion of the hydrogen-containing gas passage 20 which portion is located outside the low-temperature portion of the reforming catalyst layer 4, and the low-temperature hydrogen-containing gas can be supplied to the portion of the hydrogen-containing gas passage 20 which portion is located outside the high-temperature portion of the reforming catalyst layer 4.

Thus, also in the hydrogen generator according to Embodiment 3, it is possible to reduce the circumferential temperature variations of the reforming catalyst layer 4.

In the present embodiment, the second rotational passage 48 is formed by the four dividing walls 47a to 47d, and is formed such that the center (56a to 56d) of the second entrance (55a to 55d) of the second rotational passage 48 and the center (58a to 58d) of the second exit (57a to 57d) of the second rotational passage 48 deviate from each other so as to form 180 degrees at the angular position around the central axis 50 of the inner tube 21. With this, the hydrogen-containing gas having flowed into the third space 42 circles at 180 degrees around the central axis 50 of the inner tube 21. Thus, the circumferential temperature variations of the reforming catalyst layer 4 are reduced. However, the present embodiment is not limited to this. As long as the center (56a to 56d) of the second entrance (55a to 55d) and the center (58a to 58d) of the second exit (57a to 57d) deviate from each other so as to form about 170 to 190 degrees at the angular position around the central axis 50 of the inner tube 21, it is possible to obtain the same operational advantages as the case where the hydrogen-containing gas having flowed out from the reforming catalyst layer 4 circles at 180 degrees around the central axis 50 of the inner tube 21.

Moreover, an angle (angle formed at the angular position around the central axis 50 of the inner tube 21 by the center (56a to 56d) of the second entrance (55a to 55d) and the center (58a to 58d) of the second exit (57a to 57d)) at which the hydrogen-containing gas circles around the central axis 50 of the inner tube 21 by the second rotational passage 48 is an angle (angle formed by the high-temperature portion of the reforming catalyst layer 4, the central axis 50 of the inner tube 21, and the low-temperature portion of the reforming catalyst layer 4) preset based on the temperature of the hydrogen-containing gas having flowed out from the reformer 26 (reforming catalyst layer 4) around the central axis 50 of the inner tube 21. Such angle may be appropriately set by measuring in advance the temperature variations of the hydrogen-containing gas having flowed out from the reforming catalyst layer or by simulating the temperature distribution of the hydrogen-containing gas in the reforming catalyst layer 4.

### Embodiment 4

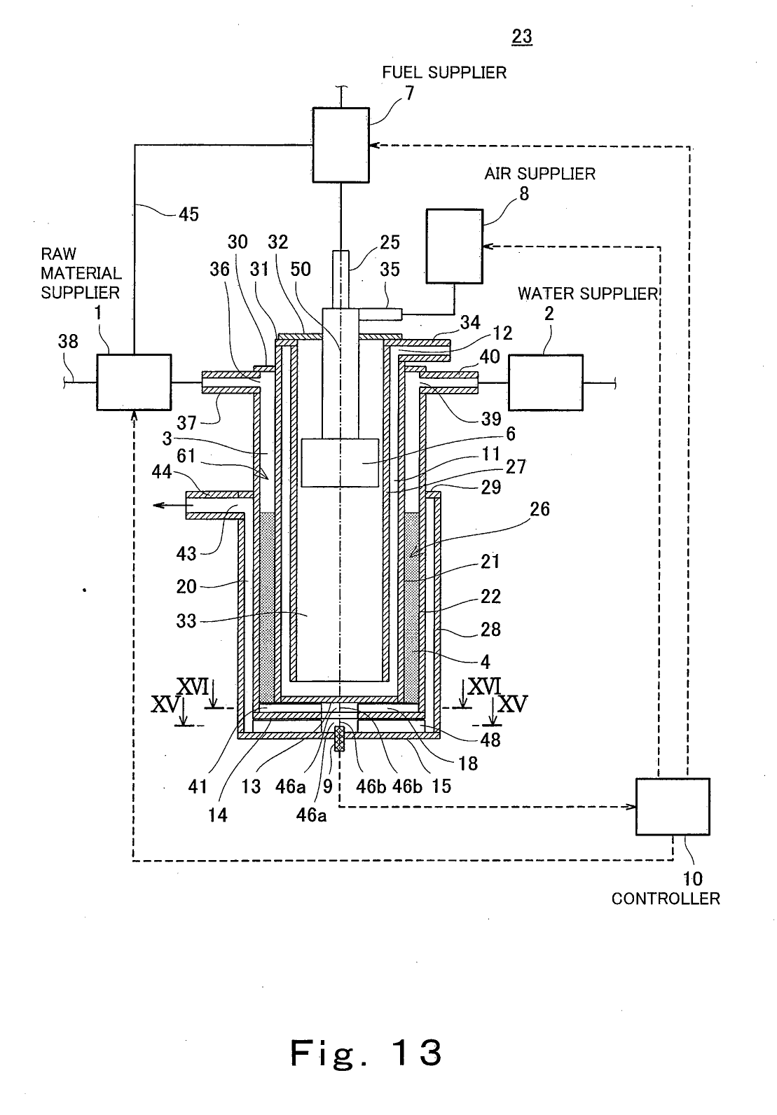

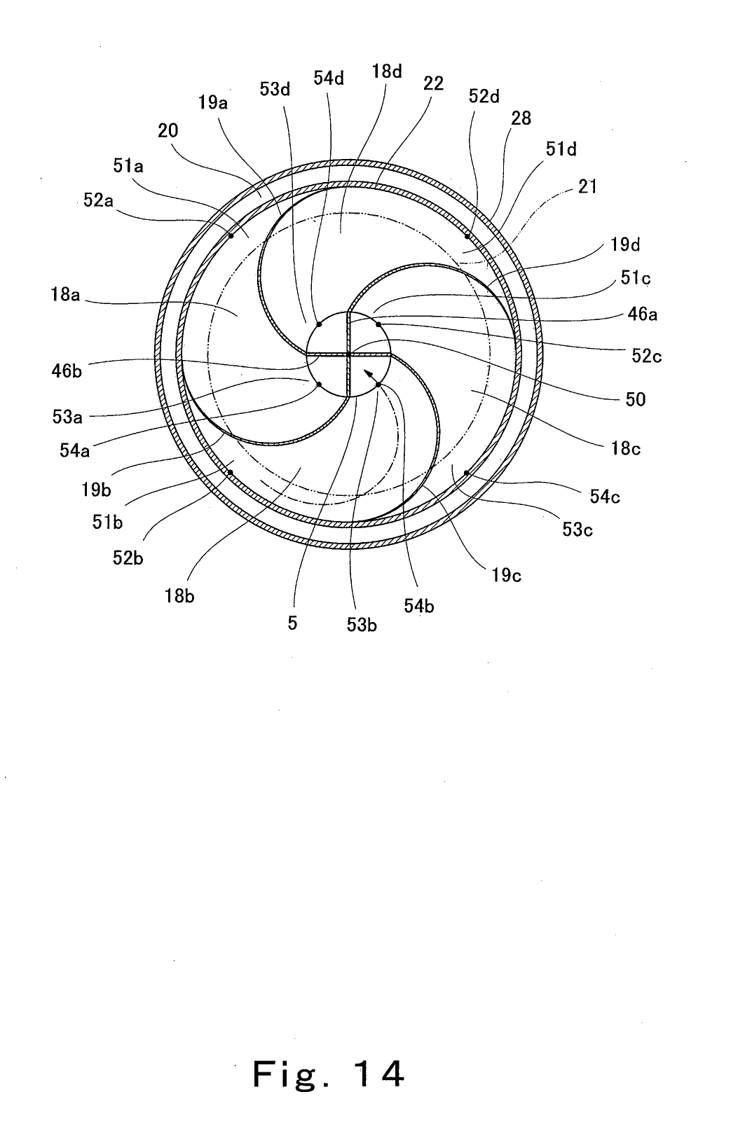

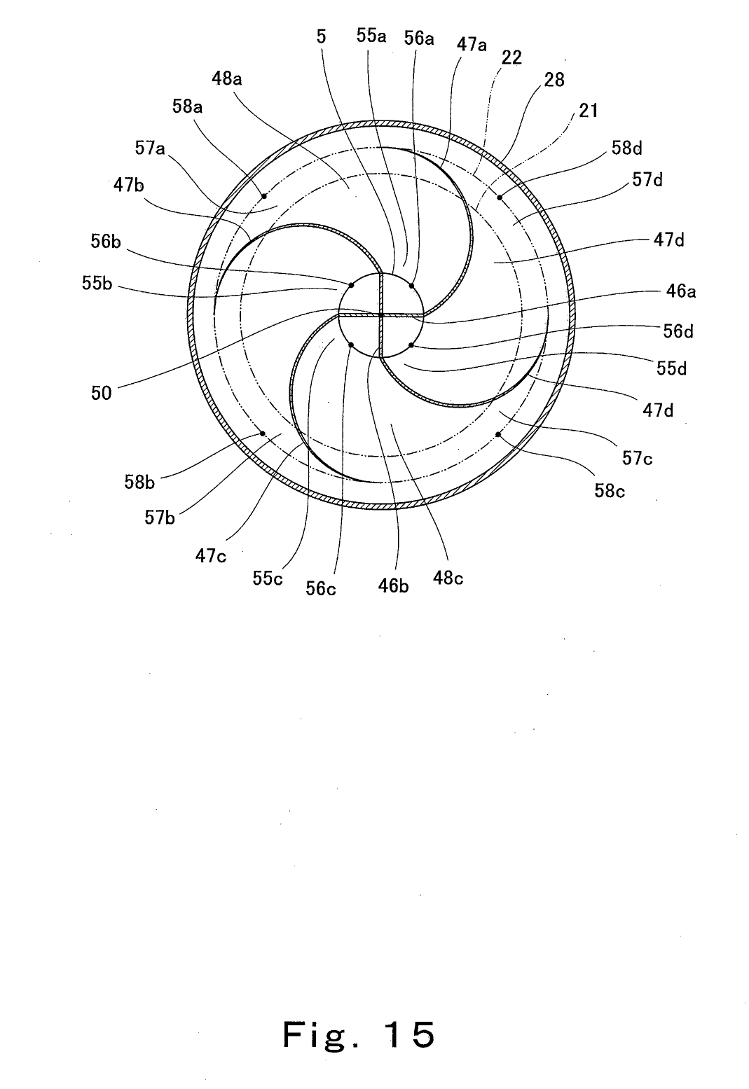

FIG. 13 is a schematic diagram showing the configuration of the hydrogen generator according to Embodiment 4 of the present invention. FIG. 14 is a cross-sectional view taken along line XIV-XIV of FIG. 13. FIG. 15 is a cross-sectional view taken along line XV-XV of FIG. 13.

As shown in FIGS. 13 to 15, the hydrogen generator 23 according to Embodiment 4 of the present invention and the hydrogen generator of Embodiment 1 of the present invention are the same in basic configuration as each other, but are different from each other in that the first rotational passage 18 is formed in the second space 41, the second rotational passage 48 is formed in the third space 42, and these two rotational passages, i.e., the first and second rotational passages 18 and 48 cause the hydrogen-containing gas, having flowed out from the reforming catalyst layer 4, to circle at a predetermined angle (for example, 180 degrees).

Specifically, the first rotational passage 18 is the same in basic configuration as the first rotational passage 18 of the hydrogen generator 23 according to Embodiment 1. However, herein, each of the first the rotational passages 18a to 18d constituting the first rotational passage 18 is formed such that the center (52a to 52d) of the first entrance (51a to 51d) and the center (54a to 54d) of the first exit (53a to 53d) form 90 degrees at the angular position around the central axis 50 of the inner tube 21. Moreover, the second rotational passage 48 is the same in basic configuration as the second rotational passage 48 of the hydrogen generator 23 according to Embodiment 3. However, herein, each of the second the rotational passages 48a to 48d constituting the second rotational passage 48 is formed such that the center (56a to 56d) of the second entrance (55a to 55d) and the center (58a to 58d) of the second exit (57a to 57d) form 90 degrees at the angular position around the central axis 50 of the inner tube 21. Further, the mix suppressing walls 46a and 46b are formed at the hydrogen-containing gas flowing port 5 side ends of the dividing walls 19a to 19d. Similarly, the mix suppressing walls 46a and 46b are formed at the hydrogen-containing gas flowing port 5 side ends of the dividing walls 47a to 47d.

With this, the hydrogen-containing gas having flowed out from the downstream end of the reforming catalyst layer 4 of the reformer 26 flows through the first the rotational passages 18a to 18d so as to circle at 90 degrees around the central axis 50 of the inner tube 21, and then passes through the hydrogen-containing gas flowing port 5. The hydrogen-containing gas having passed through the hydrogen-containing gas flowing port 5 flows through the second rotational passages 48a to 48d so as to circle at 90 degrees around the central axis 50 of the inner tube 21, and then is supplied to the hydrogen-containing gas passage 20. To be specific, the hydrogen-containing gas having flowed out from the downstream end of the reforming catalyst layer 4 of the reformer 26 circles at 180 degrees around the central axis 50 of the inner tube 21 by passing through the first and second rotational passages 18 and 48.

On this account, the high-temperature hydrogen-containing gas can be supplied to the portion of the hydrogen-containing gas passage 20 which portion is located outside the low-temperature portion of the reforming catalyst layer 4, and the low-temperature hydrogen-containing gas can be supplied to the portion of the hydrogen-containing gas passage 20 which portion is located outside the high-temperature portion of the reforming catalyst layer 4.

Thus, also in the hydrogen generator according to Embodiment 4, it is possible to reduce the circumferential temperature variations of the reforming catalyst layer 4.

In the present embodiment, the first rotational passage 18 is formed by the four dividing walls 19a to 19d, the second rotational passage 48 is formed by the four dividing walls 47a to 47d, and the first and second rotational passages 18 and 48 are formed such that the hydrogen-containing gas having flowed out from the reformer 26 circles at 180 degrees around the central axis 50 of the inner tube 21 and then flows into the hydrogen-containing gas passage 20. However, the present embodiment is not limited to this. As long as the center (52a to 52d) of the first entrance (51a to 51d) of the first rotational passage 18 and the center (58a to 58d) of the second exit (57a to 57d) of the second rotational passage 48 deviate from each other so as to form about 170 to 190 degrees at the angular position around the central axis 50 of the inner tube 21, it is possible to obtain the same operational advantages as the case where the hydrogen-containing gas having flowed out from the reforming catalyst layer 4 circles at 180 degrees around the central axis 50 of the inner tube 21.

Moreover, an angle (the sum of the angle formed at the angular position around the central axis 50 of the inner tube 21 by the center (52a to 52d) of the first entrance (51a to 51d) and the center (54a to 54d) of the first exit (53a to 53d) and the angle formed at the angular position around the central axis 50 of the inner tube 21 by the center (56a to 56d) of the second entrance (55a to 55d) and the center (58a to 58d) of the second exit (57a to 57d)) at which the hydrogen-containing gas circles around the central axis 50 of the inner tube 21 by the first and second rotational passages 48 is an angle (angle formed by the high-temperature portion of the reforming catalyst layer 4, the central axis 50 of the inner tube 21, and the low-temperature portion of the reforming catalyst layer 4) preset based on the temperature of the hydrogen-containing gas having flowed out from the reformer 26 (reforming catalyst layer 4) around the central axis 50 of the inner tube 21. Such angle may be appropriately set by measuring in advance the temperature variations of the hydrogen-containing gas having flowed out from the reforming catalyst layer or by simulating the temperature distribution of the hydrogen-containing gas in the reforming catalyst layer 4.

Further, in the present embodiment, both the angle at which the hydrogen-containing gas circles by the first rotational passage 18 and the angle at which the hydrogen-containing gas circles by the second rotational passage 48 are set to 90 degrees. However, as long as the above-described predetermined angle is determined, the angle at which the hydrogen-containing gas circles by the first rotational passage 18 and the angle at which the hydrogen-containing gas circles by the second rotational passage 48 may be set differently.

### Embodiment 5

FIG. 8 is a schematic diagram showing the configuration of a fuel cell system according to Embodiment 5 of the present invention.

As shown in FIG. 8, a fuel cell system 100 according to Embodiment 5 of the present invention includes the hydrogen generator 23 and the fuel cell 24. Used as the hydrogen generator 23 is the hydrogen generator 23 according to Embodiment 1.

The fuel cell 24 includes an anode and a cathode (both of which are not shown). The fuel gas is supplied from the hydrogen generator 23 through the fuel gas supply passage 44 to the anode, and the oxidizing gas is supplied from an oxidizing gas supplier, not shown, to the cathode. Then, the fuel cell 24 causes the fuel gas supplied to the anode and the oxidizing gas supplied to the cathode to electrochemically react with each other to generate electric power and heat. Moreover, the remaining fuel gas unused in the fuel cell 24 is supplied through the off gas passage 25 to the burner 6 of the hydrogen generator 23 as an off gas.

Moreover, the fuel cell system 100 according to Embodiment 5 is configured such that the controller 10 of the hydrogen generator 23 controls the entire fuel cell system 100. Herein, the controller 10 is configured to control the entire fuel cell system 100 as a single controller. However, the present embodiment is not limited to this. The controller 10 may be constituted by a plurality of controllers distributed, and may be configured such that these controllers control the operation of the fuel cell system 100 in cooperation with one another.

In the fuel cell system 100 according to Embodiment 5 configured as above, by using the hydrogen generator 23 according to Embodiment 1, the circumferential temperature variations of the reformer 26 (reforming catalyst layer 4) in the hydrogen generator 23 are reduced, and this makes it possible to maintain the durability of the reforming catalyst in the hydrogen generator 23. In addition, since the circumferential temperature variations of the reformer 26 (reforming catalyst layer 4) are reduced, the temperature variations of the hydrogen-containing gas detected by the temperature detector 9 are also reduced. On this account, the temperature of the reformer 26 can be stably controlled, the hydrogen is appropriately supplied to the fuel cell 24, and the fuel cell system 100 can continue to operate stably.

In Embodiments 1 to 4, the first rotational passage 18 is formed by dividing the second space 41 using the dividing walls 19a to 19d, and the second rotational passage 48 is formed by dividing the third space 42 using the dividing walls 47a to 47d. However, the present embodiment is not limited to this. Each of the first rotational passage 18 and the second rotational passage 48 may be formed in a nozzle shape. In addition, each of the inner tube 21, the outer tube 22, and the passage wall tube 28 is formed in a cylindrical shape in Embodiments 1 to 4. However, the present embodiment is not limited to this. Each of the inner tube 21, the outer tube 22, and the passage wall tube 28 may have a tubular shape, or may have, for example, a regular polygon shape.

### Reference Example 1

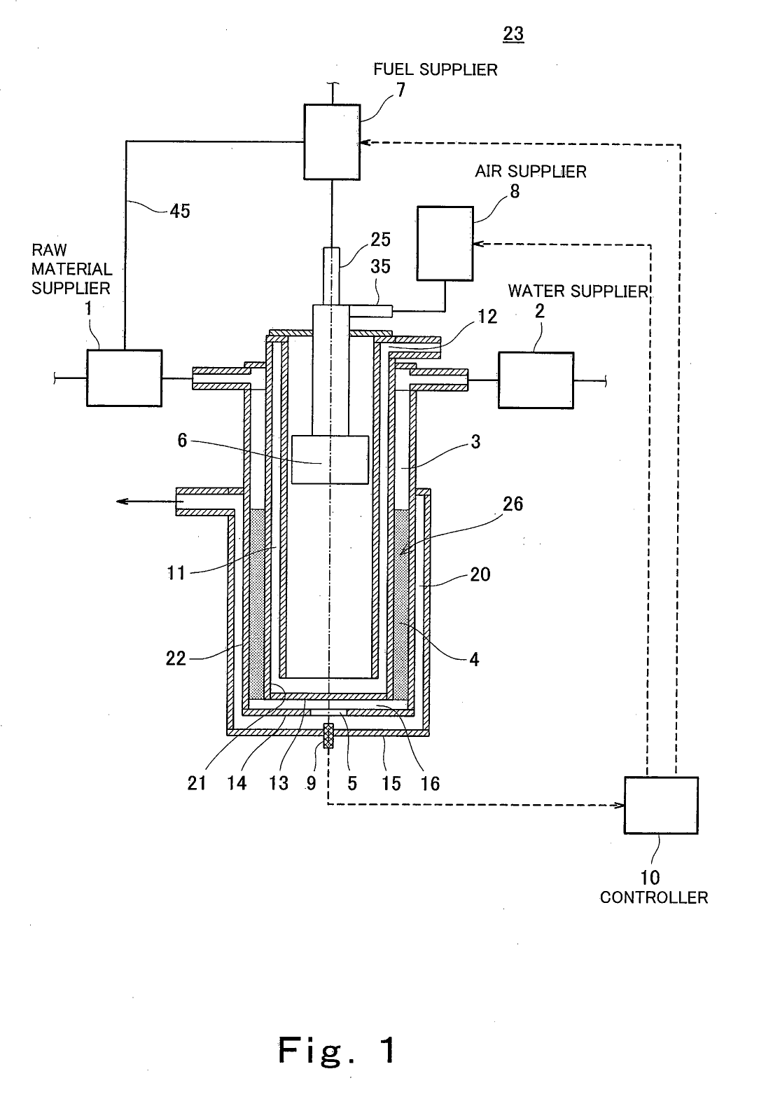

FIG. 1 is a schematic diagram showing the configuration of the hydrogen generator according to Reference Example 1.

As shown in FIG. 1, the hydrogen generator 23 includes: the raw material supplier 1 for adjusting the flow rate of the raw material containing the organic based compound made of at lest carbon and hydrogen and supplying the raw material to the hydrogen generator 23; the water supplier 2 for adjusting the flow rate of water and supplying the water to the hydrogen generator 23; the evaporator 3 which evaporates the water supplied from the water supplier 2 and generates the mixture gas of the steam and the raw material; the reforming catalyst layer 4 which is formed in an annular space between the inner tube (first tube) 21 and the outer tube (second tube) 22 and to which the mixture gas is supplied; the first lid plate 13 and the second lid plate 14 which are disposed on a downstream side of the inner tube 21 in the flow direction of the hydrogen-containing gas in the reforming catalyst layer 4 and on a downstream side of the outer tube 22 in the flow direction of the hydrogen-containing gas in the reforming catalyst layer 4, respectively; a first space 16 in which the hydrogen-containing gas having flowed out from the reforming catalyst layer 4 spreads and is mixed; the hydrogen-containing gas flowing port 5 which is formed at the center of the second lid plate 14 and at which the hydrogen-containing gas of the first space 16 gathers; the burner 6 which is disposed inside the evaporator 3 and the reforming catalyst layer 4 and generates the combustion gas which heats the evaporator 3 and the reforming catalyst layer 4; the shift converter (not shown); and the purifier (not shown). Note that the annular space between the inner tube 21 and the outer tube 22 and the reforming catalyst layer 4 constitute the reformer 26. The off gas passage 25 through which the fuel (combustion fuel: off gas or material gas) containing a combustible gas is supplied and the air supply passage 35 through which the air necessary for the combustion of the fuel is supplied are connected to the burner 6 that is the combustor of the present invention. The fuel supplier 7 is disposed at a portion of the off gas passage 25, and is connected to the raw material supplier 1 by the raw material gas supply passage 45. The air supplier 8 is disposed at the downstream end of the air supply passage 35. Then, the hydrogen generator 23 according to Reference Example 1 is configured such that based on a signal from the temperature detector 9 disposed in the vicinity of the hydrogen-containing gas flowing port 5, the controller 10 controls the amount of the fuel supplied from the fuel supplier 7 (to be precise, the raw material supplier 1) and the amount of the air supplied from the air supplier 8. The combustion gas generated by the burner 6 flows through the combustion gas passage 11 formed inside the reforming catalyst layer 4 and the inner tube 21 corresponding to an inner wall of the evaporator 3, and is discharged from the exhaust port 12. The hydrogen-containing gas having flowed out from the hydrogen-containing gas flowing port 5 flows through the hydrogen-containing gas passage 20 formed outside the reforming catalyst layer 4 via the outer tube 22, and flows out from the hydrogen generator 23.

Each of the raw material supplier 1, the water supplier 2, and the air supplier 8 may be configured to be able to adjust the flow rate of a supplied material (raw material, water, or fuel and air). Each of these suppliers 1, 2, and 8 may be, for example, a pump capable of adjusting the amount of the supplied material ejected, or a flow control valve. Moreover, the fuel supplier 7 is constituted by a three-way valve, and is configured to switch between the raw material supplier 1 and the below-described fuel cell 24 as a destination to which the burner 6 is connected.

The temperature detector 9 may be disposed anywhere as long as it can detect a temperature strongly linking to the temperature of the hydrogen-containing gas having flowed out from the hydrogen-containing gas flowing port 5. For example, the temperature detector 9 may be disposed in the hydrogen-containing gas passage in the vicinity of the hydrogen-containing gas flowing port 5, or may be disposed so as to be able to detect a surface temperature of the third lid plate 15 with which the gas having flowed out from the hydrogen-containing gas flowing port 5 contacts. Moreover, the temperature detector 9 may be suitably selected from a thermocouple, a thermistor, and the like in consideration of a detected temperature range, heat durability, and the like.

Here, the hydrogen-containing gas flowing port 5 is formed substantially at the center of the second lid plate 14 located at a lower portion of the hydrogen generator 24. With this, even in a case where the circumferential temperature variations of the reforming catalyst layer 4 are generated by circumferential nonuniformity of the flow rate of the combustion gas flowing through the combustion gas passage 11, since the hydrogen-containing gas having flowed out from the reforming catalyst layer 4 gathers at one location, the hydrogen-containing gases having the temperature differences are mixed to have a substantially uniform temperature, and since the hydrogen-containing gas flowing port 5 is formed at the center of the second lid plate 14, the distances of flow of the hydrogen-containing gases from the hydrogen-containing gas flowing port 5 to the hydrogen-containing gas passage 20 formed outside the reforming catalyst layer 4 are substantially the same as one another. Thus, the temperature and flow rate of the hydrogen-containing gas flowing through the hydrogen-containing gas passage 20 located on the outer periphery of the reforming catalyst layer 4 can be adjusted to be uniform in the circumferential direction of the annular hydrogen-containing gas passage 20. Therefore, even if the circumferential temperature variations of the reforming catalyst layer 4 are generated, it can be reduced since the heat transferred from the outer periphery of the reforming catalyst layer 4 to the reforming catalyst layer 4 is uniform.

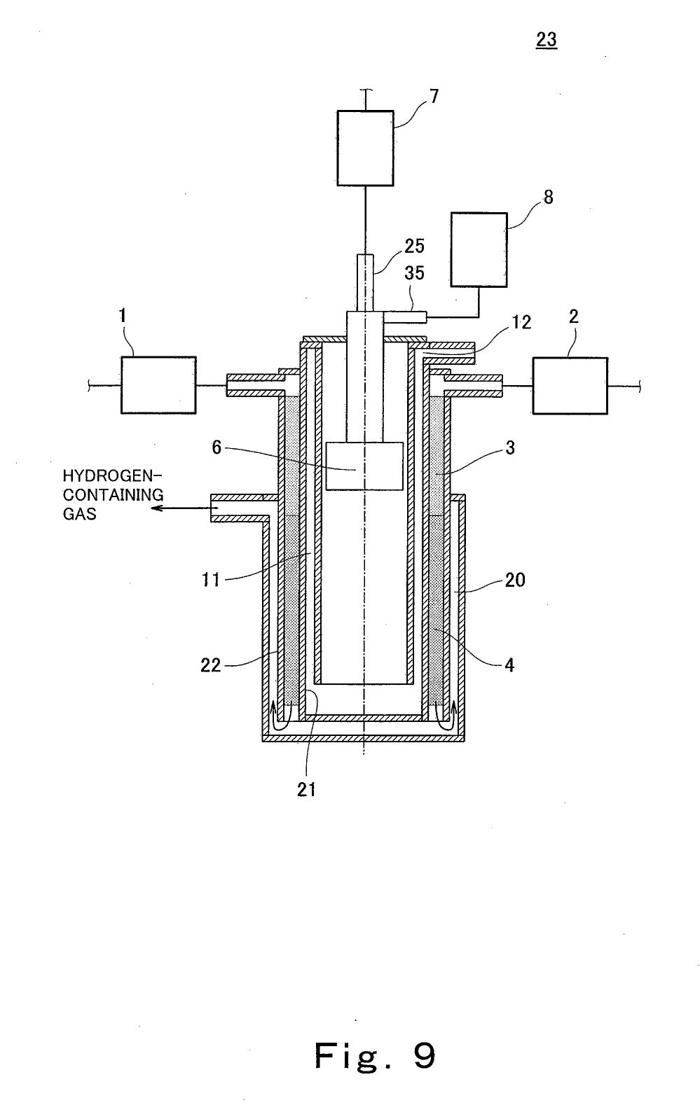

In contrast, in the above conventional hydrogen generator shown in FIG. 9, the hydrogen-containing gas having flowed out from the reforming catalyst layer 4 is not actively mixed until it reaches the hydrogen-containing gas passage 11 on the outer periphery of the reforming catalyst layer, so that the temperature of the gas is not uniformized. Therefore, in a case where the circumferential variations of the temperature distribution of the reforming catalyst layer are large, the high-temperature hydrogen-containing gas having flowed out from the high-temperature reforming catalyst layer 4 flows through a portion of the hydrogen-containing gas passage 11 which portion is located in the vicinity of the high-temperature portion of the reforming catalyst layer 4, and the low-temperature hydrogen-containing gas flows through a portion of the hydrogen-containing gas passage 11 which portion is located in the vicinity of the low-temperature portion of the reforming catalyst layer 4. On this account, the circumferential temperature variations of the reforming catalyst layer 4 are maintained.

Moreover, by disposing the temperature detector 9 in the vicinity of the hydrogen-containing gas flowing port 5 to detect the temperature of the hydrogen-containing gas, it is possible to detect the temperature of the hydrogen-containing gas which is substantially uniformized at the hydrogen-containing gas flowing port 5, even if some circumferential temperature variations of the reforming catalyst layer 4 are generated. Therefore, the detected temperature of the temperature detector 9 can be used as a typical temperature of the reformer which is determined by the temperature of the reforming catalyst layer 4.

In contrast, in the conventional hydrogen generator shown in FIG. 9, since the change of inclination of the flame generated by the combustor 6 changes the circumferential temperature variations of the reforming catalyst layer 4, it is not preferable that the controller 10 operate using the detected temperature of the hydrogen-containing gas having flowed out from the reforming catalyst layer 4 as the typical temperature of the reformer. To be specific, in the conventional hydrogen generator, in a case where the temperature of the hydrogen-containing gas having flowed out from the reforming catalyst layer 4 is detected, that is, in a case where the high temperature of the hydrogen-containing gas is detected as the typical temperature at one timing, the low temperature of the hydrogen-containing gas is detected as the typical temperature at another timing, and the controller 10 controls the combustion gas adjuster 7 or the air supplier 8 based on these detected temperatures, the temperature of the reforming catalyst may become too high that the sintering occurs, or the temperature of the reforming catalyst layer 4 may become too low that the hydrogen-containing gas is not adequately generated. Thus, it becomes difficult to stably continue to operate the hydrogen generator 23.

Because of the above, the hydrogen generator 23 of Reference Example 1 can suppress the circumferential temperature variations of the reforming catalyst layer 4, and therefore, satisfactorily maintain the durability of the reforming catalyst. In addition, since the temperature detector 9 is disposed in the vicinity of the hydrogen-containing gas flowing port 5, it is possible to detect not high/low temperatures but a uniformized temperature as the typical temperature of the reformer. Therefore, it is possible to stably operate the hydrogen generator 23 based on the detected temperature of the temperature detector 9.

In Reference Example 1, the hydrogen-containing gas flowing port 5 is formed as one opening at the center of the second lid plate 14. However, as long as the hydrogen-containing gas in the first space 16 can gather and be mixed at the center of the second lid plate 14, any configuration may be adopted. For example, a group of a plurality of small holes may be formed at the center of the second lid plate 14.

### Reference Example 2

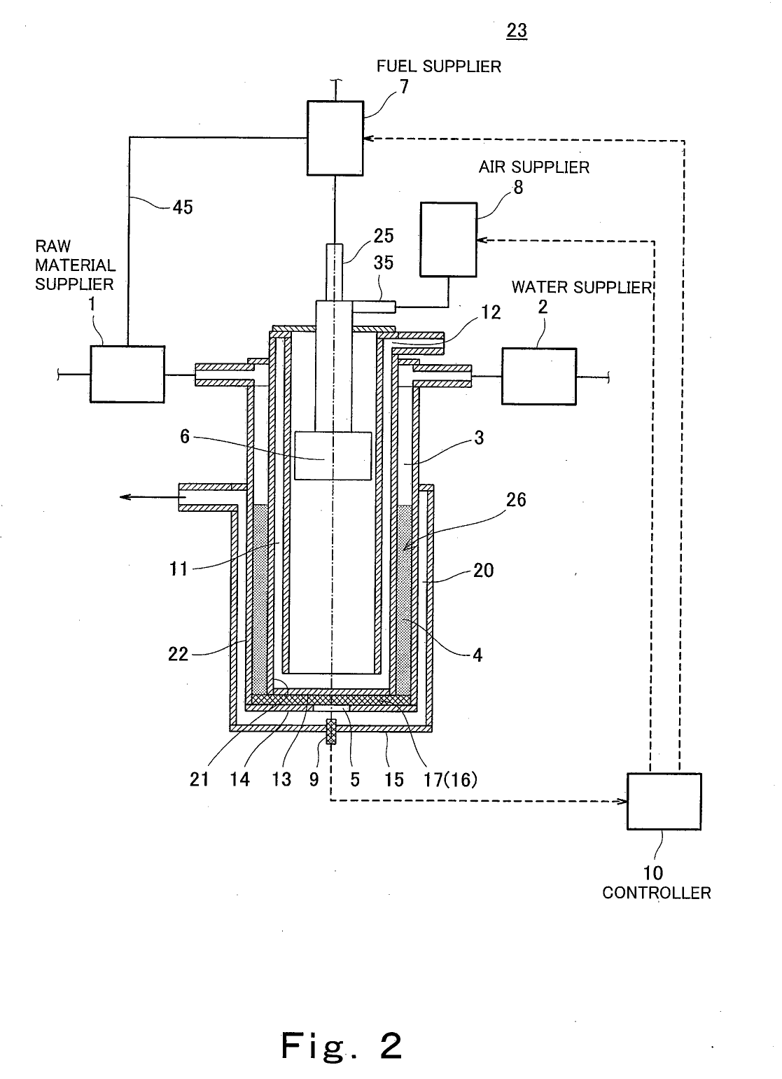

FIG. 2 is a schematic diagram showing the configuration of the hydrogen generator according to Reference Example 2.

The hydrogen generator 23 according to Reference Example 2 is configured by adding an additional component to the hydrogen generator 23 according to Reference Example 1, so that only the additional component will be explained.

As shown in FIG. 2, in the hydrogen generator 23 according to Reference Example 2, an alumina layer 17 filled with granular alumina is formed in the first space 16 between the first lid plate 13 of the inner tube 21 and the second lid plate 14 of the outer tube 22.

If the alumina layer 17 is not included, the second lid plate 14 is heated by heat radiation from the first lid plate 13 heated by the combustion gas from the burner 6, the third lid plate 15 is heated by the heat radiation from the second lid plate 14, and the heat is released from the hydrogen generator 23. If the heat generated in the burner 6 is not effectively used, the reformer 26 requires a large amount of fuel to generate hydrogen. Thus, the hydrogen generator deteriorates in efficiency.

Therefore, by forming the alumina layer 17 as in Reference Example 2, the heat release to the outside of the reformer is suppressed since the alumina layer 17 receives the heat from the high-temperature first lid plate 13. Thus, the heat of the burner 6 can be utilized effectively.

In Reference Example 2, alumina is used as a filled material. However, any material can be used as long as it has a heat insulation property and can allow the gas in the first space 16 to pass therethrough.

### Reference Example 3

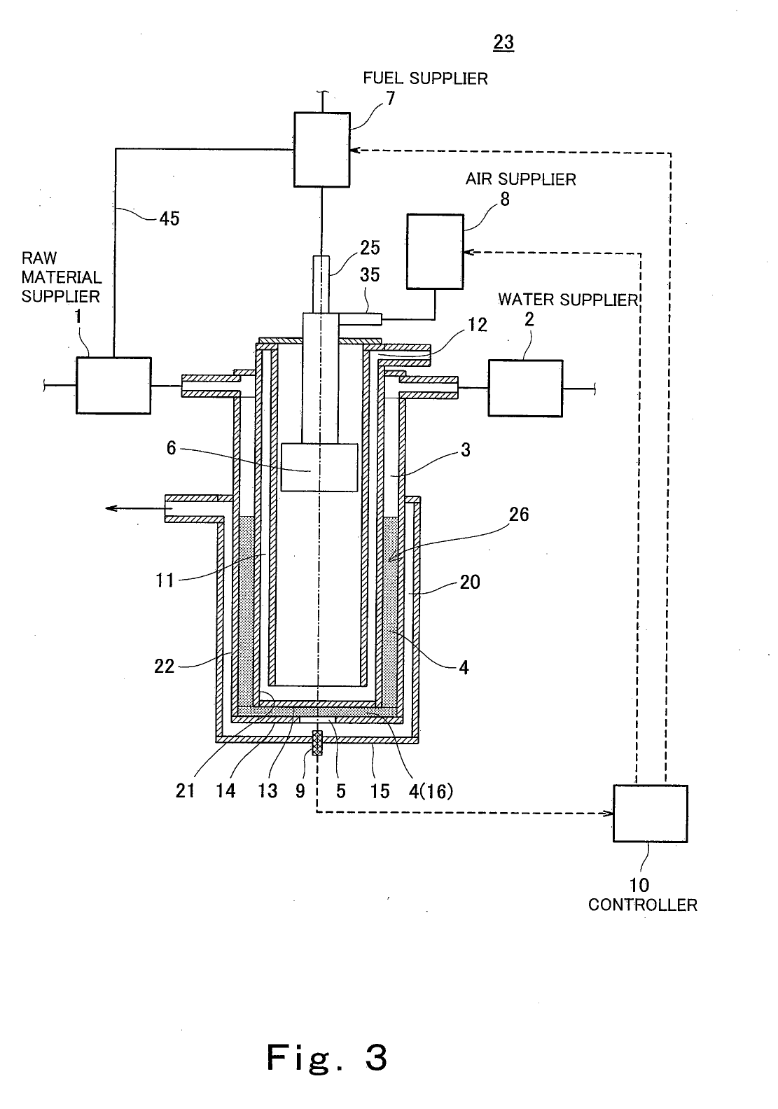

FIG. 3 is a schematic diagram showing the configuration of the hydrogen generator according to Reference Example 3.

As shown in FIG. 3, the hydrogen generator 23 according to Reference Example 3 is configured by adding to the hydrogen generator 23 according to Reference Example 1, a reforming catalyst filled in the first space 16 between the first lid plate 13 of the inner tube 21 and the second lid plate 14 of the outer tube 22.

With this, since the reforming catalyst in the first space 16 receives the heat from the first lid plate 13 heated by the combustion gas from the burner 6, the heat release from the reformer 26 can be suppressed, and the reforming reaction can proceed in the reforming catalyst layer in the first space 16. Therefore, it is possible to increase the generation of the hydrogen by the same structure size and the same heat supply from the burner 6 as the hydrogen generator 23 of Reference Example 1. Thus, it is possible to further improve the efficiency of the hydrogen generator 23.

From the foregoing explanation, many modifications and other embodiments of the present invention are obvious to one skilled in the art. Therefore, the foregoing explanation should be interpreted only as an example, and is provided for the purpose of teaching the best mode for carrying out the present invention to one skilled in the art. The structures and/or functional details may be substantially modified within the spirit of the present invention.

### INDUSTRIAL APPLICABILITY

The hydrogen generator of the present invention can reduce the circumferential temperature variations of the reforming catalyst which are generated by the unstable flow rate of the combustion gas flowing through a portion inside the tubular reforming catalyst layer, so that it is possible to maintain the durability of the reforming catalyst. For example, the hydrogen generator of the present invention is useful as a hydrogen generator for use in a domestic fuel cell system.

1. A hydrogen generator comprising:
a first tube, a first end of which is closed by a first lid plate;
a combustor configured to generate flame generated from a second end of the first tube toward the first end of the first tube in an internal space of the first tube to combust a combustion fuel;
a combustion gas passage configured to allow the combustion gas to flow therethrough along an inner surface of the first tube;
a second tube, a first end of which is closed by a second lid plate having a hydrogen-containing gas flowing port at a center thereof, and which is disposed outside the first tube to be coaxial with the first tube and disposed such that the second lid plate is opposed to the first lid plate;
a reformer including a reforming catalyst layer disposed in a tubular first space formed between the first tube and the second tube; and
a third tube, a first end of which is closed by a third lid plate, and which is disposed outside the second tube to be coaxial with the second tube and disposed such that the third lid plate is opposed to the second lid plate, wherein:
a plurality of hydrogen-containing gas rotational passages are formed in at least one of a second space formed between the first lid plate and the second lid plate and a third space formed between the second lid plate and the third lid plate, so as to be arranged in a circumferential direction of the first tube, each of the rotational passages include an entrance communicated with the first space and an exit communicated with a tubular fourth space formed between the second tube and the third tube, and a center of the entrance and a center of the exit deviate from each other so as to form a predetermined angle at an angular position around a central axis of the first tube; and
a raw material and water are supplied from a second end of the second tube to the first space, a reforming reaction between the raw material and the water is carried out in the reforming catalyst layer by heat transferred from the combustion gas passage to generate a hydrogen-containing gas, and the hydrogen-containing gas flows from the first end of the first tube of the first space through the second space, the hydrogen-containing gas flowing port of the second lid plate, the third space, and the fourth space to an outside of the hydrogen generator.

2. The hydrogen generator according to claim 1, wherein: the plurality of the rotational passages are formed in the second space; the entrances (hereinafter referred to as “first entrances”) of the rotational passages (hereinafter referred to as “first rotational passages”) formed in the second space are communicated with the first space; and the exits (hereinafter referred to as “first exits”) of the first rotational passages are communicated with the fourth space via the hydrogen-containing gas flowing port.

3. The hydrogen generator according to claim 2, wherein the center of the first entrance of the first rotational passage and the center of the first exit of the first rotational passage deviate from each other so as to form an angle of 170 to 190 degrees at the angular position around the central axis of the first tube.

4. The hydrogen generator according to claim 2, wherein the first rotational passages are formed by dividing the second space using dividing walls extending in an axial direction of the first tube.

5. The hydrogen generator according to claim 1 or 2, wherein: the plurality of the rotational passages are formed in the third space; the entrances (hereinafter referred to as “second entrances”) of the rotational passages (hereinafter referred to as “second rotational passages”) formed in the third space are communicated with the first space via the hydrogen-containing gas flowing port; and the exits (hereinafter referred to as “second exits”) of the second rotational passages are communicated with the fourth space.

6. The hydrogen generator according to claim 5, wherein the center of the second entrance of the second rotational passage and the center of the second exit of the second rotational passage deviate from each other so as to form an angle of 170 to 190 degrees at the angular position around the central axis of the first tube.

7. The hydrogen generator according to claim 5, wherein the second rotational passages are formed by dividing the third space using dividing walls extending in an axial direction of the first tube.

8. The hydrogen generator according to claim 1, further comprising a temperature detector in a vicinity of the hydrogen-containing gas flowing port.

9. The hydrogen generator according to claim 8, further comprising:
a fuel supplier configured to supply fuel to the combustor; and
a controller, wherein
the controller is configured to control an amount of the fuel supplied from the fuel supplier to the combustor, based on a temperature detected by the temperature detector.

10. A fuel cell system comprising:
the hydrogen generator according to claim 1; and
a fuel cell configured to generate electric power using the hydrogen-containing gas supplied from the hydrogen generator.
